(19) United States
(12) Patent Application Publication
(10) Pub. No.: US 2017/0064170 A1
(43) Pub. Date: Mar. 2, 2017

(54) OPTICAL TRANSMISSION UNIT AND IMAGE CAPTURING APPARATUS

(71) Applicant: CANON KABUSHIKI KAISHA, Tokyo (JP)

(72) Inventor: Toshiyuki Sudo, Utsunomiya-shi (JP)

(21) Appl. No.: 15/237,783

(22) Filed: Aug. 16, 2016

(30) Foreign Application Priority Data
Sep. 1, 2015 (JP) 2015-171658
Jul. 29, 2016 (JP) 2016-149122

(51) Int. Cl. H04N 5/225; G02B 23/26; G02B 5/00; G02B 23/24

(52) U.S. Cl. CPC H04N 5/2256; G02B 23/243; G02B 23/26; G02B 23/2484; G02B 5/005; H04N 2005/2255

(57) ABSTRACT

An optical transmission unit includes a plurality of optical transmission paths, a first aperture limiter configured to limit an aperture on an entrance end of each of the plurality of optical transmission paths, a second aperture limiter configured to limit an aperture on an exit end of each of the plurality of optical transmission paths; and a moving unit configured to rotationally move, around an optical axis direction of the transmission paths, at least one of the plurality of optical transmission paths, the first aperture limiter, and the second aperture limiter so that a moving direction and a moving amount of the aperture limited by the first aperture limiter can be equal to those of the aperture limited by the second aperture limiter.

### BACKGROUND OF THE INVENTION

Field of the Invention

The present invention relates to an optical (or light) transmission unit and an image capturing apparatus.

Description of the Related Art

Recently, a high resolution image has been increasingly demanded for an image capturing apparatus, such as an endoscope. Japanese Patent Laid-Open No. 58-17403 discloses an image transmission path that includes a mask disposed in front of an entrance end plane of a bundle of many optical fiber wires in an arrangement state, and a lens configured to project incident light that has passed the mask onto an optical fiber. The mask has an enlarged size of the entrance end plane and lowers a transmittance of part that does not contribute to an image transmission. A pixel slide and a pixel shift are known as a conventional resolution enhancement method.

Japanese Patent Laid-Open No. 2011-221170 proposes an aperture shape for a Nipkow disk, and Japanese Patent No. 5408809 proposes a torque coil.

A configuration of Japanese Patent Laid-Open No. 58-17403 is effective in improving a contrast of an image obtained from the light through the image transmission path, but cannot improve the resolution of the image. The above conventional resolution enhancement means needs an image sensor having a high frame rate and an image processor having a high calculation processing capability.

### SUMMARY OF THE INVENTION

The present invention provides an optical transmission unit (light transmission device) and an image capturing apparatus, which can comparatively easily provide a high resolution image.

An optical transmission unit according to one aspect of the present invention includes a plurality of optical (or light) transmission paths, a first aperture limiter (opening limiter) configured to limit an aperture (opening) on an entrance end of each of the plurality of optical transmission paths, a second aperture limiter configured to limit an aperture on an exit end of each of the plurality of optical transmission paths, and a moving unit (actuator) configured to rotationally move, around an optical axis direction of the transmission paths, at least one of the plurality of optical transmission paths, the first aperture limiter, and the second aperture limiter so that a moving (or displacement) direction and a moving amount (displacement amount) of the aperture limited by the first aperture limiter can be equal to those of the aperture limited by the second aperture limiter.

Further features of the present invention will become apparent from the following description of exemplary embodiments with reference to the attached drawings.

### BRIEF DESCRIPTION OF THE DRAWINGS

FIG. 1 is a schematic configuration diagram of a fiber scope according to a first embodiment of the present invention.

FIGS. 2A and 2B are plane views of end planes of a fiber bundle and a mask illustrated in FIG. 1 according to the first embodiment.

FIG. 3 illustrates driving control by a drive controller illustrated in FIG. 1 according to the first embodiment.

FIGS. 4A to 4C are graphs of time characteristics of an aperture movement and exposure in case of FIG. 3 according to the first embodiment.

FIG. 5 is a view of an aperture distribution multiplexed by an image generating unit illustrated in FIG. 1 according to the first embodiment.

FIGS. 6A to 6C illustrate an object example illustrated in FIG. 1, an object image captured by a conventional fiber scope, and an object image captured by the fiber scope illustrated in FIG. 1.

FIG. 7 illustrates light intensity distributions on an exit side mask obtained by the drive control illustrated in FIG. 3 according to the first embodiment.

FIG. 8 illustrates a variation of FIG. 7 according to the first embodiment.

FIG. 9 is a schematic configuration diagram of a fiber scope according to a second embodiment of the present invention.

FIGS. 10A to 10C are views of entrance end plane of a fiber bundle, a mask, and a combined aperture distribution illustrated in FIG. 9 according to the second embodiment.

FIG. 11 illustrates a drive control by a drive controller illustrated in FIG. 9 according to the second embodiment.

FIGS. 12A and 12B are graphs of time characteristics of an aperture movement and exposure in case of FIG. 11 according to the second embodiment.

FIG. 13 illustrates an aperture distribution multiplexed by an image generating unit illustrated in FIG. 9 according to the second embodiment.

FIGS. 14A and 14B are views of an aperture distribution on a mask according to a third embodiment of the present invention.

FIG. 15 illustrates an aperture distribution multiplexed with the mask illustrated in FIG. 14A according to the third embodiment.

FIGS. 16A and 16B illustrate an aperture distribution on a mask according to the third embodiment of the present invention.

FIG. 17 illustrates an aperture distribution multiplexed with the mask illustrated in FIG. 16B according to the third embodiment.

FIG. 18 illustrates an aperture distribution multiplexed with the mask illustrated in FIG. 16B according to the third embodiment.

FIG. 19 illustrates an aperture distribution multiplexed with the mask illustrated in FIG. 16B according to the third embodiment.

FIG. 20 illustrates an aperture distribution multiplexed with the mask illustrated in FIG. 16B according to the third embodiment.

FIG. 21 is a sectional view of a hexagonal close-packed fiber bundle.

FIG. 22 illustrates geometric parameters of the hexagonal close-packed fiber bundle.

FIG. 23 illustrates the fiber bundle combined with an Archimedean spiral arrangement with a=R/π.

FIG. 24 illustrates the fiber bundle combined with the Archimedean spiral arrangement with a>R/π.

FIG. 25 illustrates the fiber bundle combined with the Archimedean spiral arrangement with a<R/π.

FIG. 26 is a view for explaining an aperture position determining method.

FIG. 27 is a view for explaining a method for replacing a peripheral aperture position in a radial direction.

### DESCRIPTION OF THE EMBODIMENTS

A description will now be given of a variety of embodiments of the present invention, with reference to the accompanying drawings.

### First Embodiment

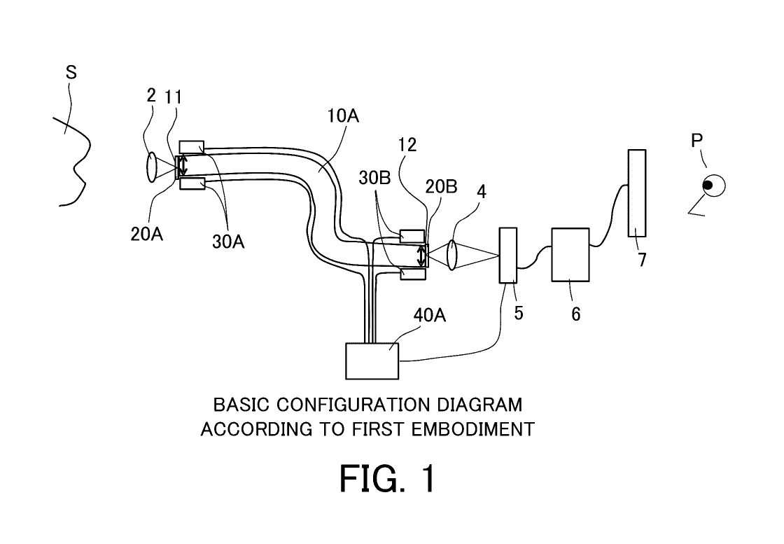

FIG. 1 is a schematic base configuration diagram of a fiber scope (endoscope, image capturing apparatus) according to a first embodiment of the present invention. The fiber scope according to the first embodiment includes an objective lens 2, an optical transmission unit, a relay lens 4, an image senor (image pickup device or photoelectric converter) 5, an image generating unit (image generator) 6, a monitor (display unit) 7. The optical transmission unit includes a fiber bundle (transmission path unit) 10A, masks 20A, 20B, actuators (drivers) 30A, 30B, and a drive controller 40A.

The objective lens 2 forms an optical image (object image) of an object S on an entrance end plane 11 on the object side of the fiber bundle 10A via the mask (first mask) 20A. The fiber bundle 10 includes a plurality of optical fibers (a plurality of optical transmission paths). The objective lens 2 enables the light from the object to enter each optical fiber in the fiber bundle 10A. A light flux that has entered each optical fibers propagates in the optical fiber without interfering with another light flux, and exits from an exit end plane 12 on the opposite side of the fiber bundle 10A through the mask (second mask) 20B. The relay lens 4 forms an image of the exit light on an image capturing plane of the image sensor 5. The image sensor 5 photoelectrically converts an optical image of the object transmitted by the optical transmission unit. The captured image is A/D-converted, and receives a plurality of types of processes by the image generating unit (image generator) 6 connected to the image sensor 5, is converted into an image, and is supplied to an observer P via the monitor (display unit) 7.

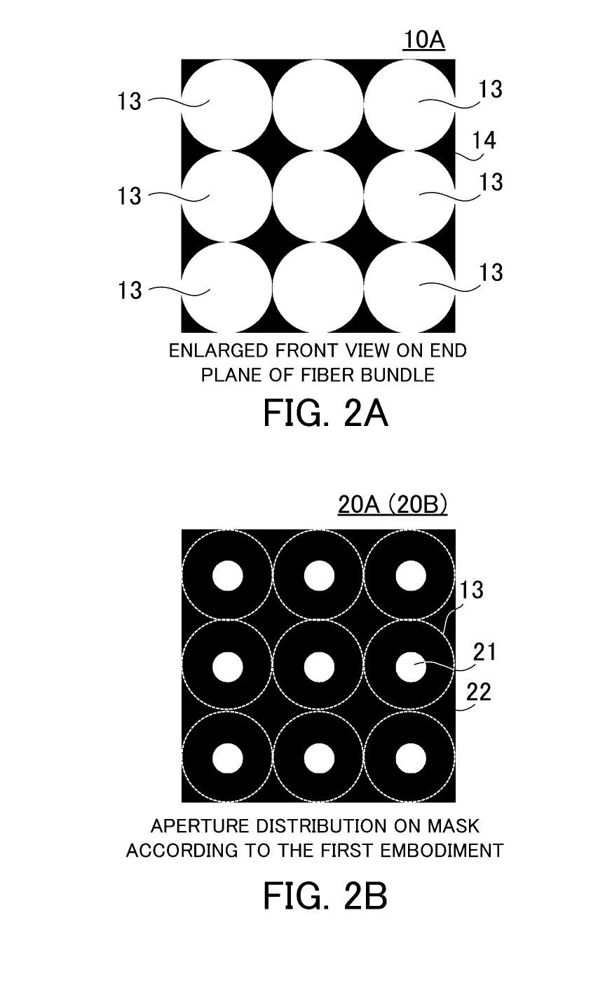

FIG. 2A is an enlarged plane view of the end plane of the fiber bundle 10A. In FIG. 2A, a white region denotes an aperture (core) 13 in the optical fiber, and a black region denotes a light blocking portion (light shielding mask or clad) 14 that does not contribute to an optical transmission. Each optical fiber extends in a direction perpendicular to the paper plane of FIG. 2A. In the fiber bundle 10A, a plurality of apertures 13 are arranged in a 3×3 square matrix shape, and a plurality of optical fibers are densely adjacent to each other.

The mask 20A is integrally provided onto the fiber bundle 10A on the entrance end plane 11 on the object side of the fiber bundle 10A. In other words, the mask 20A is fixed onto the entrance end plane 11 by an unillustrated fixer. The mask 20A serves as a first aperture limiter configured to limit each aperture (or aperture diameter) 13 in each entrance end among the plurality of optical fibers. The mask 20B is integrated with the fiber bundle 10A on the exit end plane 12 on the image senor side of the fiber bundle 10A. In other words, the mask 20B is fixed onto the exit end plane 12 by an unillustrated fixer. The mask 20B serves as a second aperture limiter configured to limit each aperture 13 (or aperture diameter) in each the exit end among the plurality of optical fibers. The configurations of the first and second aperture limiters are not limited to the masks according to this embodiment, and may employ another configuration such as a mechanical structure and an optical structure. For example, the aperture limiter may be a clad material blended with a light absorber or a light blocking portion.

The actuators 30A and 30B and the drive controllers 40A serve as a moving unit configured to move at least one of the fiber bundle 10A and the masks 20A and 20B. The moving unit provides a movement such that a moving amount and a moving direction of each aperture (or the aperture 21) limited by the mask 20A are equal to those of each aperture (or the aperture 21) limited by the mask 20B. The moving unit can move all of the plurality of optical fibers and the masks 20A and 20B, only the masks 20A and 20B, or only the plurality of optical fibers. The movements of the apertures limited by the masks 20A and 20B may be relative movements to the optical fibers. In this case, the moving unit provides a movement such that a moving direction and a moving amount of the apertures 21 in the mask 20A relative to the apertures 13 on the entrance end are equal to those of the apertures 21 in the mask 20B relative to the apertures 13 on the exit end. The term “equal,” as used herein, allows a slight error caused by an error of an individual difference, a manufacturing error, and a control error. The movement may be a rotational movement around an optical axis direction (center axis direction) of the optical fibers, as described later. The optical axis direction (center axis direction) of the optical fibers means a normal direction at the center (center of gravity) on the entrance end or the exit end of the optical fibers.

FIG. 2B is a plane view of the masks 20A and 20B, while the apertures 13 in the fiber bundle 10A is drawn transparent. Each mask includes the apertures 21 as white regions, and a light blocking portion 22 as a black region. The aperture 21 has an area smaller than that of the aperture 13 and thereby limits the incident light to and exit light from each optical fiber. The aperture 21 in the mask 20A is as large as the aperture in the mask 20B. The aperture 21 one-to-one corresponds to each aperture 13, and the number of apertures 21 is equal to that of the number of fibers. In FIG. 2B, a contour of each aperture 13 illustrated in FIG. 2A is illustrated by a white broken line. In this embodiment, each aperture 21 has a diameter one-third as long as that of the aperture 13.

The actuator 30A moves the mask 20A in a plane orthogonal to the optical axis of the optical fiber at the entrance end, and the actuator 30B moves the mask 20B in a plane orthogonal to the optical axis of the optical fiber at the exit end. Since the mask 20A is fixed onto the entrance end plane 11 of the fiber bundle 10A, the actuator 30A moves the mask 20A and the entrance end plane 11 together. Since the mask 20B is fixed onto the exit end plane 12 of the fiber bundle 10A, the actuator 30B moves the mask 20B and the exit end plane 12 together. These two actuators 30A and 30B are connected to the drive controller 40A, and a moving amount, a moving direction, and a timing of each actuator are controlled by the drive controller 40A. The drive controller 40A is connected to the image sensor 5, and can synchronously communicate a signal with the image sensor 5. The drive controller 40A synchronizes the movements by the actuators 30A and 30B with the image acquiring timing by the image sensor 5.

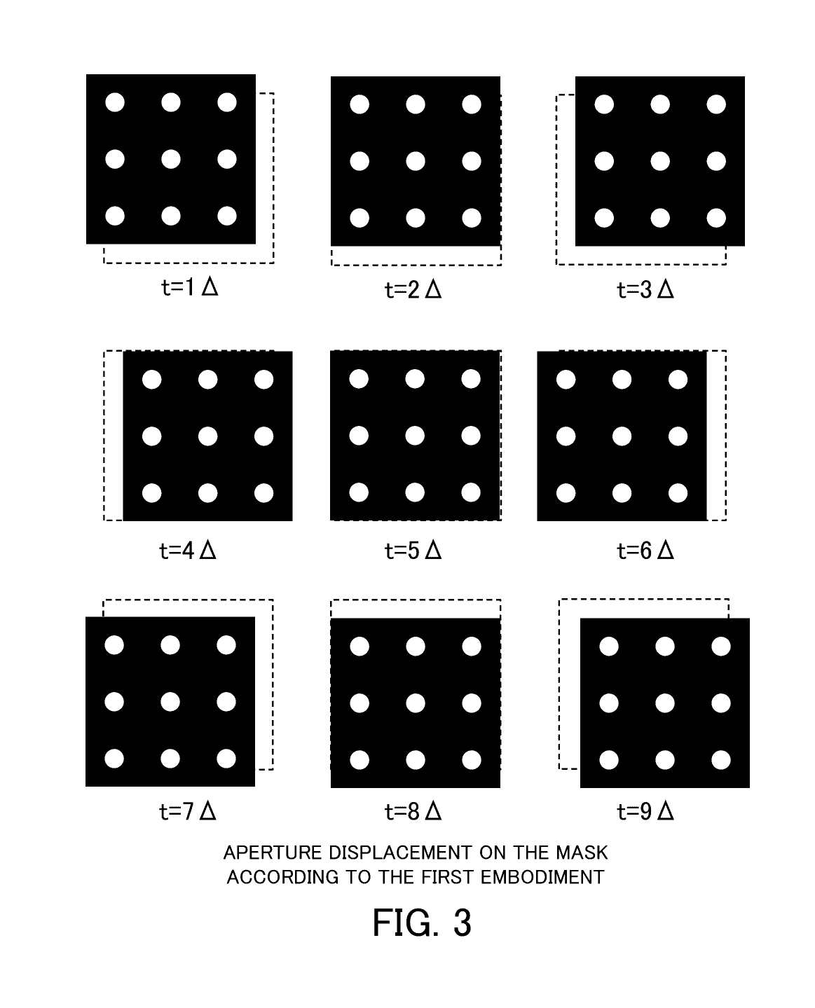

FIG. 3 is a front view of aperture movements with time of the masks 20A and 20B controlled by the drive controller 40A. An X axis is set in the right direction, and a Y axis is set in the down direction. A broken line illustrates a position at t=5Δ. In FIG. 3, the moving unit two-dimensionally translates the masks 20A and 20B in a plane perpendicular to the optical axis of the fiber bundle 10.

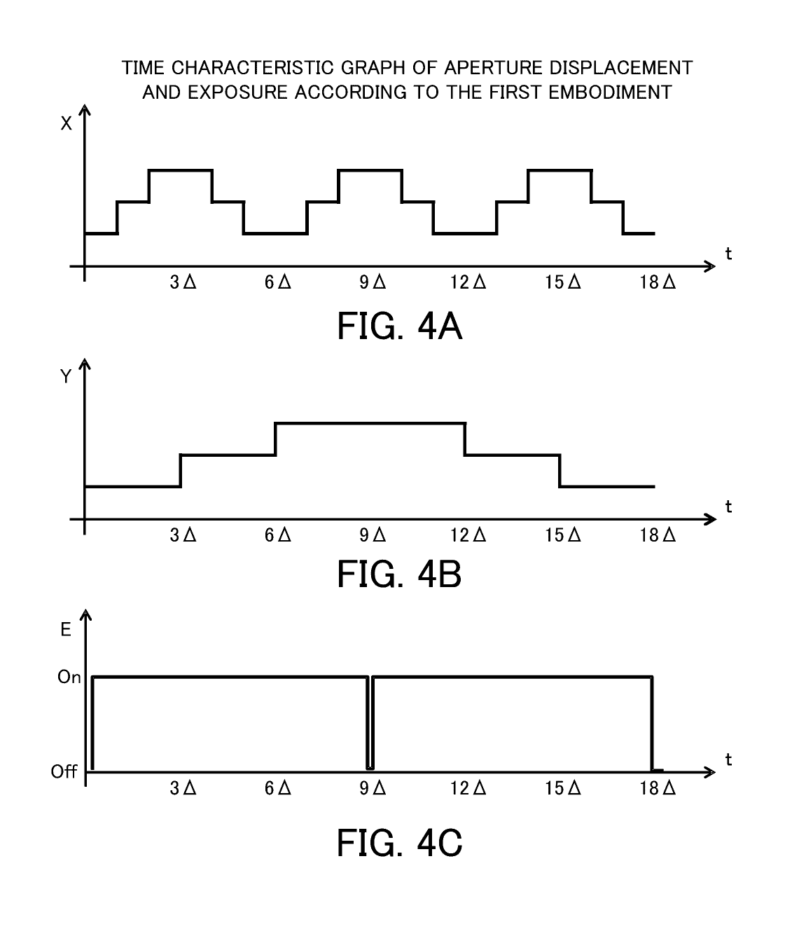

FIG. 4A is a graph illustrating a relationship between the moving amounts (ordinate axis) of the masks 20A and 20B and the fiber bundle 10A in the X direction, and time t (abscissa axis). FIG. 4B is a graph illustrating a relationship between the moving amounts (ordinate axis) of the masks 20A and 20B and the fiber bundle 10A in the Y direction, and time t (abscissa axis).

When the initial position is set to a position at time t=1Δ, the drive controller 40A moves the masks 20A and 20B and the fiber bundles 10A from the position of t=1Δ by a predetermined amount (+1) in the X direction at time t=2Δ. At time t=3Δ, the drive controller 40A moves the masks 20A and 20B and the fiber bundles 10A from the position of t=2Δ by a predetermined amount (+1) in the X direction.

At time t=4Δ, the drive controller 40A moves the masks 20A and 20B and the fiber bundles 10A from the position of t=3Δ by a predetermined amount (+1) in the Y direction. At time t=5Δ, the drive controller 40A moves the masks 20A and 20B and the fiber bundles 10A from the position of t=4Δ by a predetermined amount (−1) in the X direction. At time t=6Δ, the drive controller 40A moves the masks 20A and 20B and the fiber bundles 10A from the position of t=5Δ by a predetermined amount (−1) in the X direction.

At time t=7Δ, the drive controller 40A moves the masks 20A and 20B and the fiber bundles 10A from the position of t=6Δ by a predetermined amount (+1) in the Y direction. At time t=8Δ, the drive controller 40A moves the masks 20A and 20B and the fiber bundles 10A from the position of t=7Δ by a predetermined amount (+1) in the X direction. At time t=9Δ, the drive controller 40A moves the masks 20A and 20B and the fiber bundles 10A from the position of t=8Δ by a predetermined amount (+1) in the X direction.

FIG. 4C is a graph illustrating a relationship between the exposure (ordinate axis) of the image sensor 5 and time t (abscissa axis). Herein, “on” is an exposure state, and “off” is a non-exposure state. The exposure can be controlled by controlling an illustrated electronic shutter of the image sensor 5.

As illustrated in FIG. 4C, at time of t=1Δ to 9Δ, the exposure is performed. In other words, the position in the X direction changes for each minimum step unit Δ of time t, and there are three stages of X coordinates. The position in the Y direction changes for each step of 3Δ, and there are three stages of Y coordinates. As a result, there are totally nine stages of aperture positions. The movement in the Y direction contains moving up and down, and eventually exhibits a repetitive movement motion with a period of 18Δ. An exposure time period is set to the image sensor 5 so that 9Δ is one frame time period.

FIG. 3 illustrates the aperture movement on the mask viewed from the entrance side or the exit side. As described above, the moving unit moves the masks 20A and 20B so that the moving direction and the moving amount of the aperture 13 limited by the mask 20A are equal to those of the aperture 13 limited by the mask 20B when the masks 20A and 20B are viewed from the entrance side or the exit side. For example, assume that the mask 20A and the image sensor side of the mask 20B are overlapped and viewed from the entrance side at time t=1Δ, as illustrated in FIG. 3. Then, the apertures 13 move as illustrated in FIG. 3 at time t=2Δ to 9Δ.

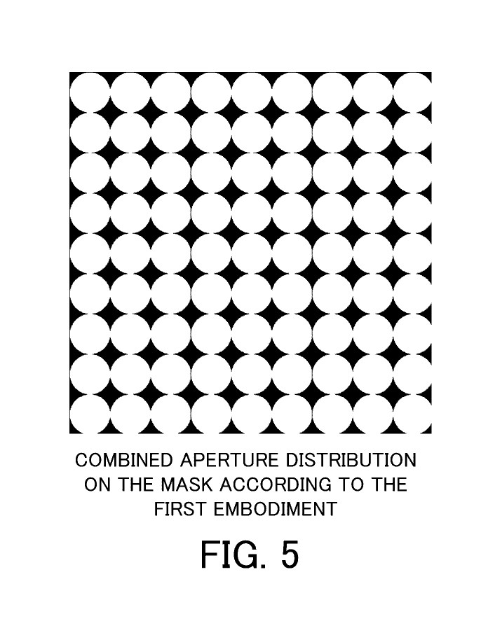

The image generating unit 6 is configured to combine image data obtained from the image sensor 5 and forms an image at each of the positions of the masks 20A and 20B moved by the moving unit. As evident from FIGS. 4A to 4C, the available positions of the mask 20A and 20B in one frame are combined and recorded as if they are multi-exposed at a slow shutter speed, and the high resolution image is obtained through the combined apertures as illustrated in FIG. 5. As described above, since the image sensor 5 and the drive controller 40A synchronously communicate the signal, this operation is available. The image generating unit 6 may perform other processes, such as a white balance, a gamma correction, and a demosaic process, for the image data captured by the image sensor 5.

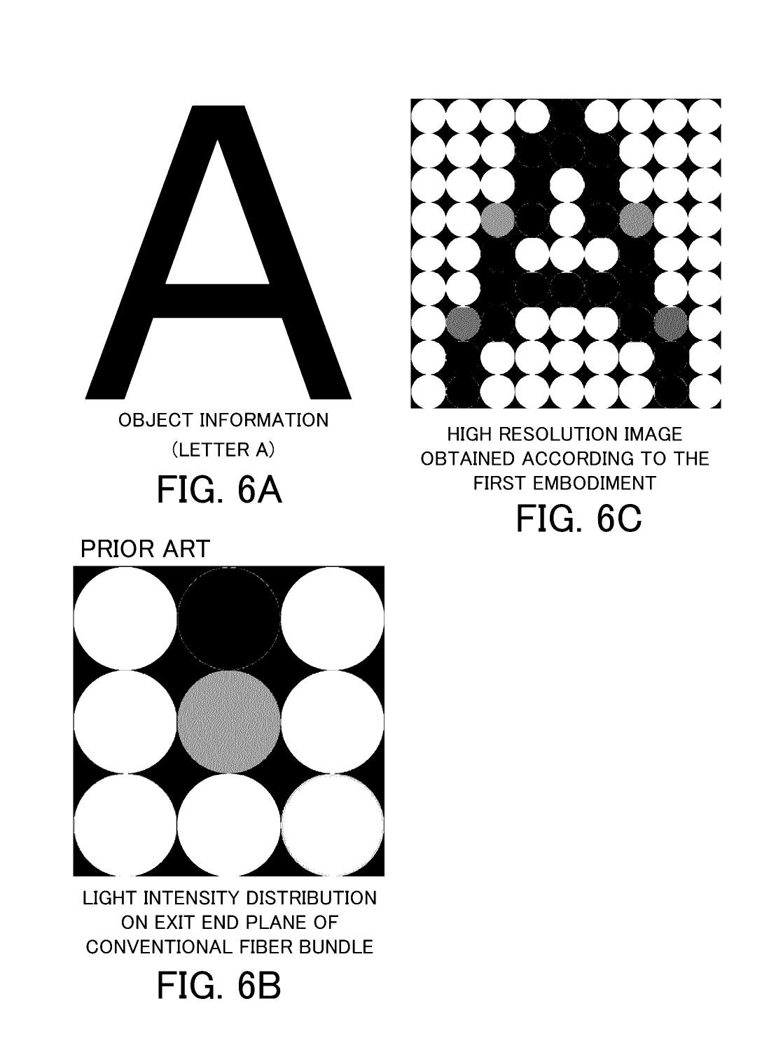

Assume that the object S is a letter “A” illustrated in FIG. 6A, and the light intensity distribution of “A” is formed on the entrance end surface 11 of the fiber bundle 10A by the objective lens 2 in the conventional structure that has no masks 20A and 20B, no actuators 30A and 30B, and no drive controller 40A. Since the incident light independently propagates in each optical fiber, the light intensity distribution finer than the optical fiber diameter is averaged when it reaches the exit end, and a low resolution light intensity distribution sampled for each optical fiber appears on the exit end plane 12, as illustrated in FIG. 6B. FIG. 6B is an intensity distribution of the letter “A” sampled for each optical fiber and illustrated in FIG. 6A in the conventional fiber scope, and the resolution of the letter A is lost.

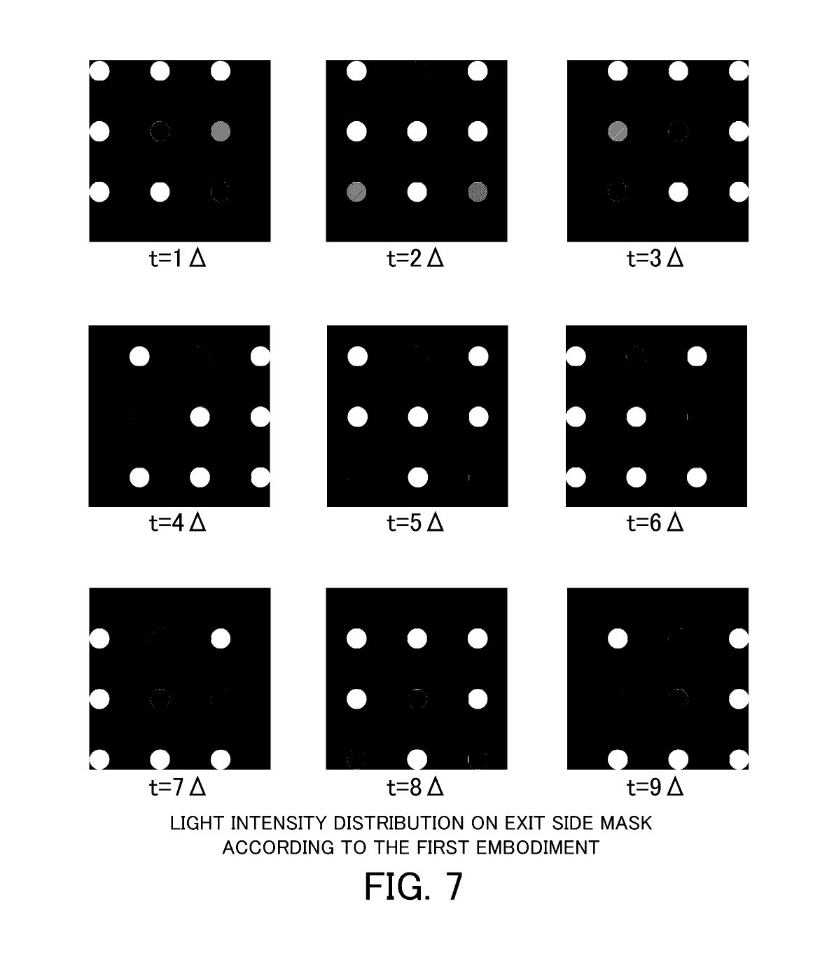

On the other hand, according to the first embodiment, the light intensity distribution on the exit end of the fiber bundle 10A changes as illustrated in FIG. 7. When this is received by the image sensor 5 in which the exposure time period for one frame is set to 9Δ, a high resolution image having a resolution nine times as high as that of the conventional fiber scope illustrated in FIG. 6B can be acquired. A time period necessary to move the apertures limited by the masks to all positions is set to the exposure time period for one frame when these apertures are moved in the X and Y directions orthogonal to the optical axis.

The resolution of the image sensor 5 is set equal to or higher than the resolution of the high resolution image. In other words, a minimum size of a pixel in the image sensor 5 is as large as or smaller than each aperture in the masks 20A and 20B. This embodiment uses the image sensor 5 having the number of pixels that is at least nine times as many as the number of optical fibers in the fiber bundle 10A. Thereby, the high resolution illustrated in FIG. 5 (FIG. 6C) can be acquired.

While the first embodiment obtains an image having a ninefold resolution by longitudinally and laterally moving, by three steps, the masks 20A and 20B having the aperture diameter that is one-third as long as that of the aperture 13, another resolution image can be similarly obtained. In the generalization, assume that the aperture 13 has an aperture width (opening width) of Wx in the X direction (first direction), and an aperture width of in the Y direction (second direction). Herein, the Y direction is orthogonal to the X direction and the optical axis (Z direction) of the fiber bundle 10A. The aperture in the masks 20A and 20B has an aperture diameter of Wx/m in the X direction and an aperture diameter of Wy/n in the Y direction, where m and n are integers. Then, the drive controller 40 provides a movement of m steps in the X direction and n steps in the Y direction in one frame so as to finally acquire an image with a resolution of m×n times.

While this embodiment moves the fiber bundle 10A and masks 20A and 20B together, the fiber bundle 10A and the masks 20A and 20B may be relatively moved, for example, by fixing the fiber bundle 10A and by synchronously moving the mask 20A and 20B.

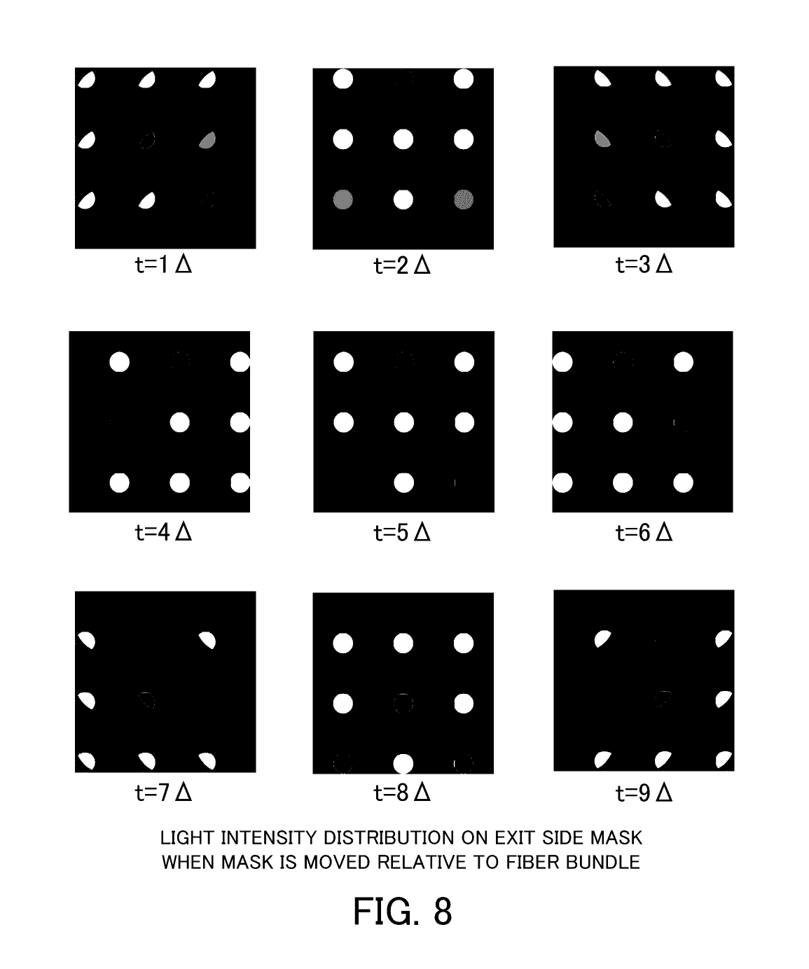

FIG. 8 illustrates light intensity distributions on the mask 20B when the masks 20A and 20B are moved relative to the fiber bundle 10A. Due to the movements of the masks 20A and 20B relative to the fiber bundle 10A, light is shielded by the light blocking portion 14 illustrated in FIG. 2A but the light intensity distribution timewise changes similar to FIG. 7, and the high resolution can be also realized.

Since the mask 20A is fixed onto the entrance end plane 11 of the fiber bundle 10, and the mask 20B is fixed onto the entrance end plane 12 of the fiber bundle 10 in FIG. 3, the positions of the masks 20A and 20B do not change relative to the apertures 13. Hence, the moving unit moves the masks 20A and 20B so that the moving direction and the moving amount of the apertures limited by the mask 20A can be equal to those of the apertures limited by the mask 20B.

In FIG. 8, the mask 20A is movable relative to the entrance end plane 11, and the mask 20B is movable relative to the exit end plane 12 of the fiber bundle 10. Each aperture 21 is an aperture limited by the masks 20A and 20B. The moving unit moves the masks 20A and 20B so that the moving direction (driving direction) and the moving amount (driving amount) of the aperture 21 relative to the aperture 13 can be equal between the mask 20A and 20B.

For a higher resolution, the drive controller controls driving of the actuators 30A and 30B so that the aperture movement on the entrance end plane 11 of the fiber bundle 10A can be equal to the aperture movement on the exit end plane 12 at any time. The conventional resolution enhancement method, such as the pixel slide and pixel shift, moves the entrance end plane of the fiber bundle but does not move the exit end plane, and performs image restoration processing with a heavy calculation load for plural pieces of obtained low resolution image data for a higher resolution image. Thus, the conventional method needs an image sensor having a high frame rate and an image processor having a high calculation processing capability. On the other hand, this embodiment does not require a high-speed image sensor or a high-speed calculation system, and thus can comparatively easily provide a high-resolution image, facilitating the cost reduction and promoting the widespread use.

### Second Embodiment

The first embodiment needs two actuators 30A and 30B so as to move the entrance end plane 11 and the exit end plane 12 of the fiber bundle 10A. It is particularly difficult for a small-diameter fiber scope to provide the actuator on the entrance end side, and a small diameter scheme may be impaired. Accordingly, this embodiment does not dispose the actuator on the entrance end side and disposes the actuator only on the exit end side, generates a similar movement on the entrance end, and realizes a high resolution.

This embodiment uses a so-called torque coil. The torque coil is a product would around a fiber, a catheter, a cable, etc., and when one distal end on a driven component is rotated, the opposite end is driven by the same amount. The torque coil can rotate the entrance end surface by providing a rotational motion to the exit end side, even if the actuator is not provided on the entrance end side of the fiber bundle. Thus, the torque coil rotationally moves the exit side of the fiber bundle through the rotational driving force by the actuator (rotational driver), and serves as a transmitter configured to transmit a rotational driving force applied by the actuator to the entrance side of the fiber bundle. The second embodiment disposes a torque coil in a concentric shape around the fiber bundle, and realizes a high resolution using a rotation.

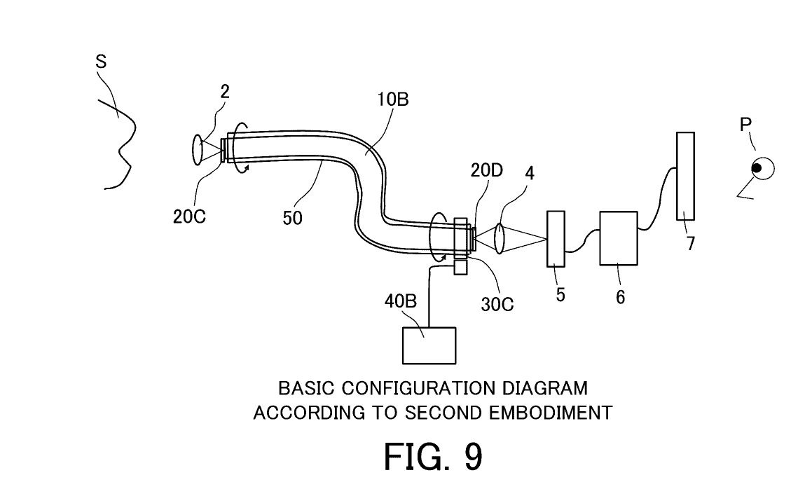

FIG. 9 is a configuration diagram of a fiber scope (endoscope, image capturing apparatus) according to a second embodiment of the present invention. The fiber scope according to the second embodiment includes an optical transmission unit, an objective lens 2, a relay lens 4, an image senor (image pickup device or photoelectric converter) 5, an image generating unit (image generator) 6, a monitor (display unit) 7. The optical transmission unit includes a fiber bundle (transmission path unit) 10B, masks 20C and 20D, an actuators (drivers) 30C, a drive controller 40B, and a torque coil 50. Those elements in FIG. 9, which are corresponding elements in FIG. 1, will be designated by the same reference numerals, and a description thereof will be omitted. The optical transmission unit according to this embodiment has no actuator 30A, but includes the torque coil 50 would around the fiber bundle 10B. The actuator 30C is attached to the exit side of the fiber bundle 10B.

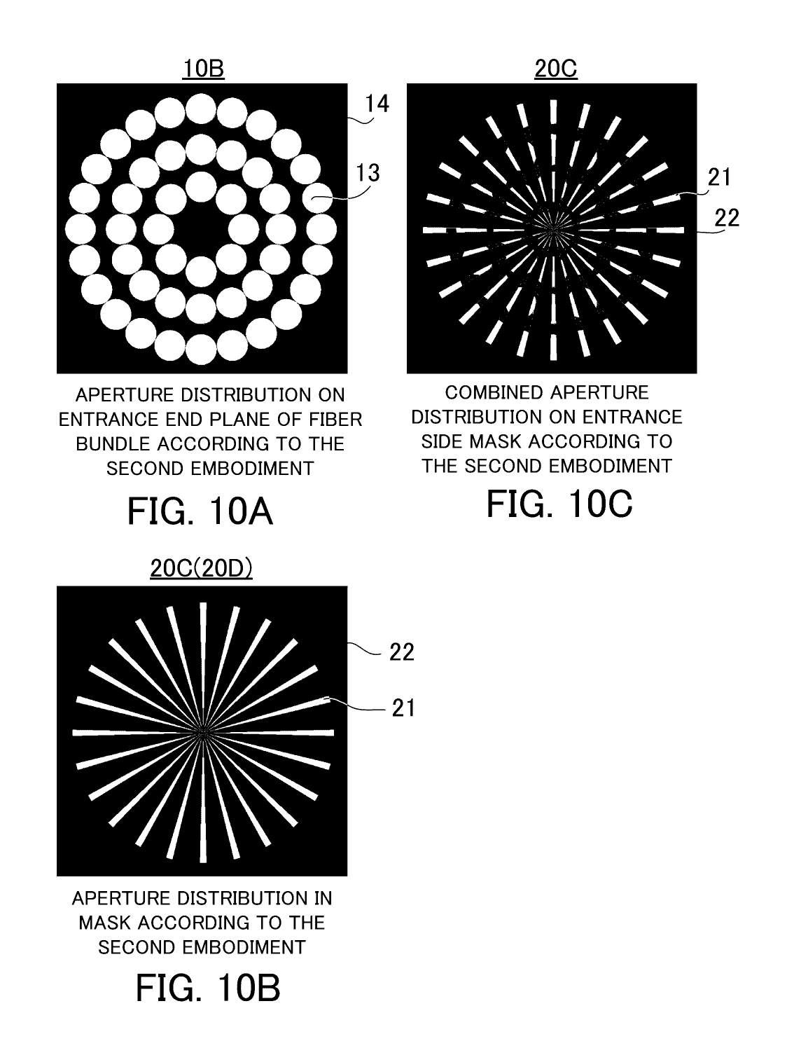

FIG. 10A is a plane view of the entrance end plane of the fiber bundle 10B. The fiber bundle 10B is different from the fiber bundle 10A in arrangement of the apertures 13 and the light blocking portion 14, because a plurality of apertures 13 are concentrically arranged. The center of the concentric circles is the center of the fiber bundle 10B. FIG. 10B is a plane view of each of the masks 20C and 20D. Each of the masks 20C and 20D has apertures 21 as white regions each of which extends in the radial direction from the (rotation) center of the fiber bundle 10B, and the light blocking portion 22 as a black region. Each aperture 21 has the same isosceles triangle or fan shape having a central angle of 3°, and 24 apertures 21 are arranged at regular angular intervals (or 15° intervals herein). The center of the fiber bundle 10B accords with the centers of the masks 20C and 20D. FIG. 10C is a plane view of the apertures in the fiber bundle 10B viewed through the masks 20C and 20D.

The fiber bundle 10B may include a shaft formed by a plurality of spirally wound wires. The torque coil 50 may be a coil member formed by a single coil wire spirally wound around an outer circumference surface of the fiber bundle 10B. A winding direction of each of a plurality of wires is the same as a winding direction of a single coil wire. The torque coil 50 is engaged with the fiber bundle 10B via a non-engagement part that is not engaged with wires of the fiber bundle 10B. The torque coil 50 can be fed between ends of the fiber bundle 10B when the fiber bundle 10B is rotated by the actuator 30C.

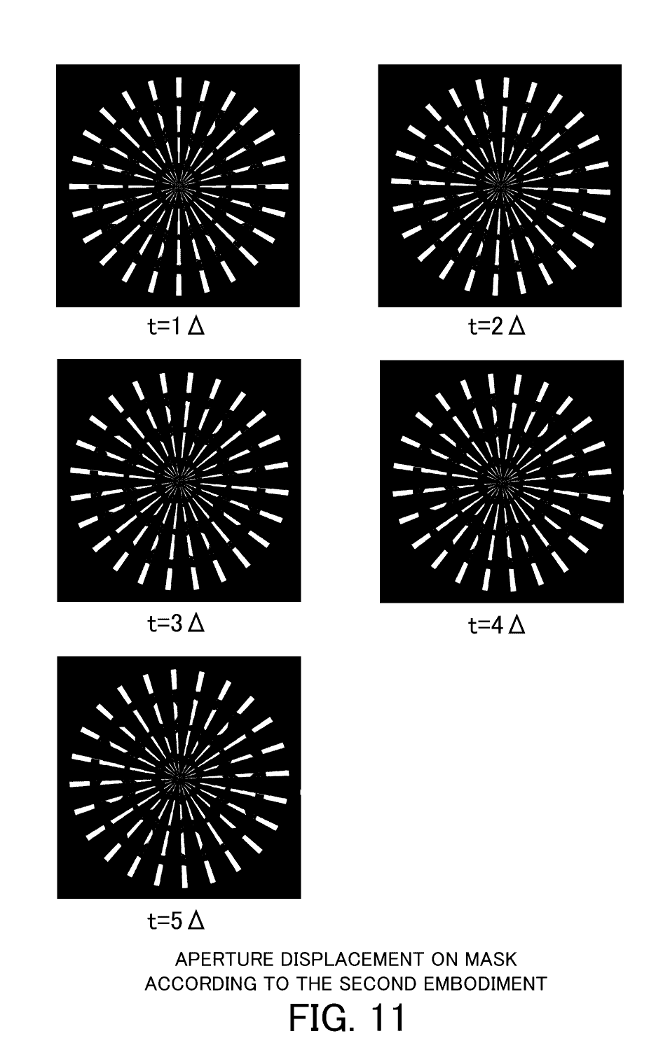

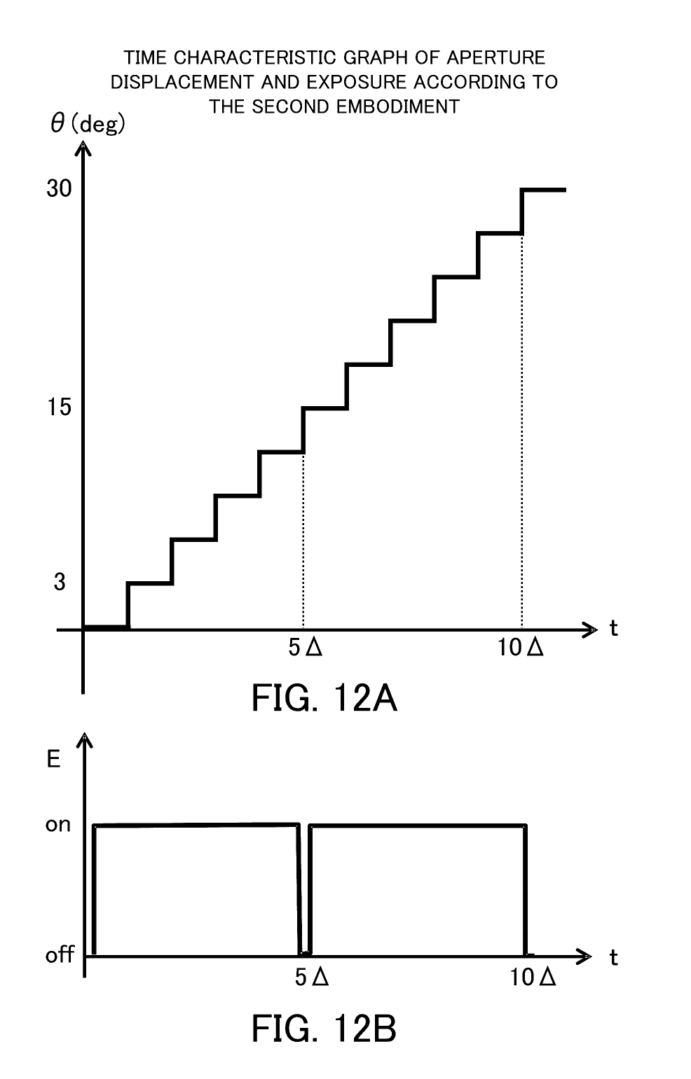

FIG. 11 illustrates front views of aperture movements with time of the masks 20C and 20D controlled by the drive controller 40B. FIG. 12A is a graph illustrating a relationship between the rotational moving amounts (angular moving amount) of the masks 20C and 20D and the fiber bundle 10B (ordinate axis), and time t (abscissa axis). FIG. 12B is a graph illustrating a relationship between the exposure of the image sensor 5 (ordinate axis), and time t (abscissa axis).

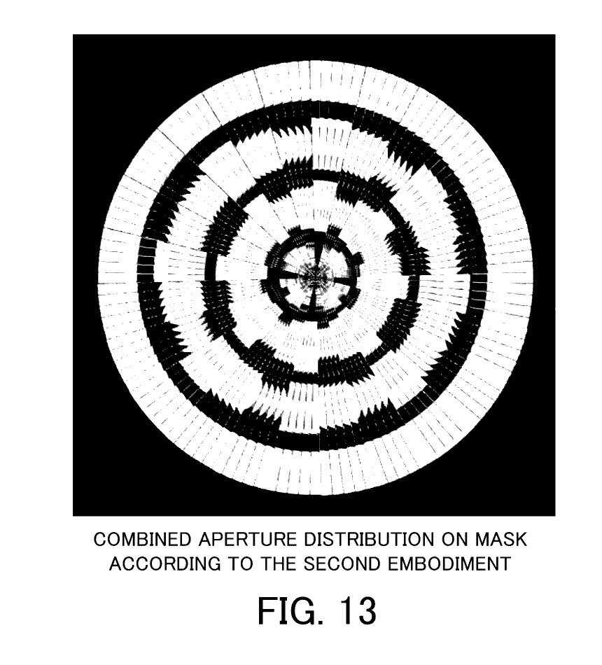

The rotational moving amount changes for each minimum step unit Δ of time t, and there are five stages of rotation angles. An exposure time period is set to the image sensor 5 so that 5Δ is one frame time period. Similar to the first embodiment, due to multiplexed available positions of the mask in one frame, the image generating unit 6 multiplexes the combined apertures in this period, as illustrated in FIG. 13. The resolution of this combined apertures is much higher than that of the core on the end plane of the fiber bundle 10B. Similar to the first embodiment, this embodiment acquires the image through this procedure, and realizes a high-resolution image having a resolution five times as high as that of the conventional fiber scope.

This embodiment configures a fiber scope that provides a high resolution image without providing an actuator on the entrance end side by transmitting a rotational motion on the exit end side of the fiber bundle 10B to the entrance end side of the fiber bundle 10B through the torque coil 50. In other words, this embodiment has an effect of reconciling a small diameter scheme of the fiber scope and a resolution enhancement configuration. The fiber bundle combined with the masks 20C and 20D illustrated in FIG. 10B may have an aperture arrangement of the Nipkow disc, which will be described later, or an aperture arrangement on the Archimedean spiral.

### Third Embodiment

In the second embodiment, as illustrated in FIG. 10C, the aperture positions in the circumferential direction can be sequentially multiplexed by the rotational motion. However, a resolution enhancement direction is biased since the aperture positions cannot be multiplexed in the radial direction. Accordingly, this embodiment provides a method for easily and uniformly improving the resolution.

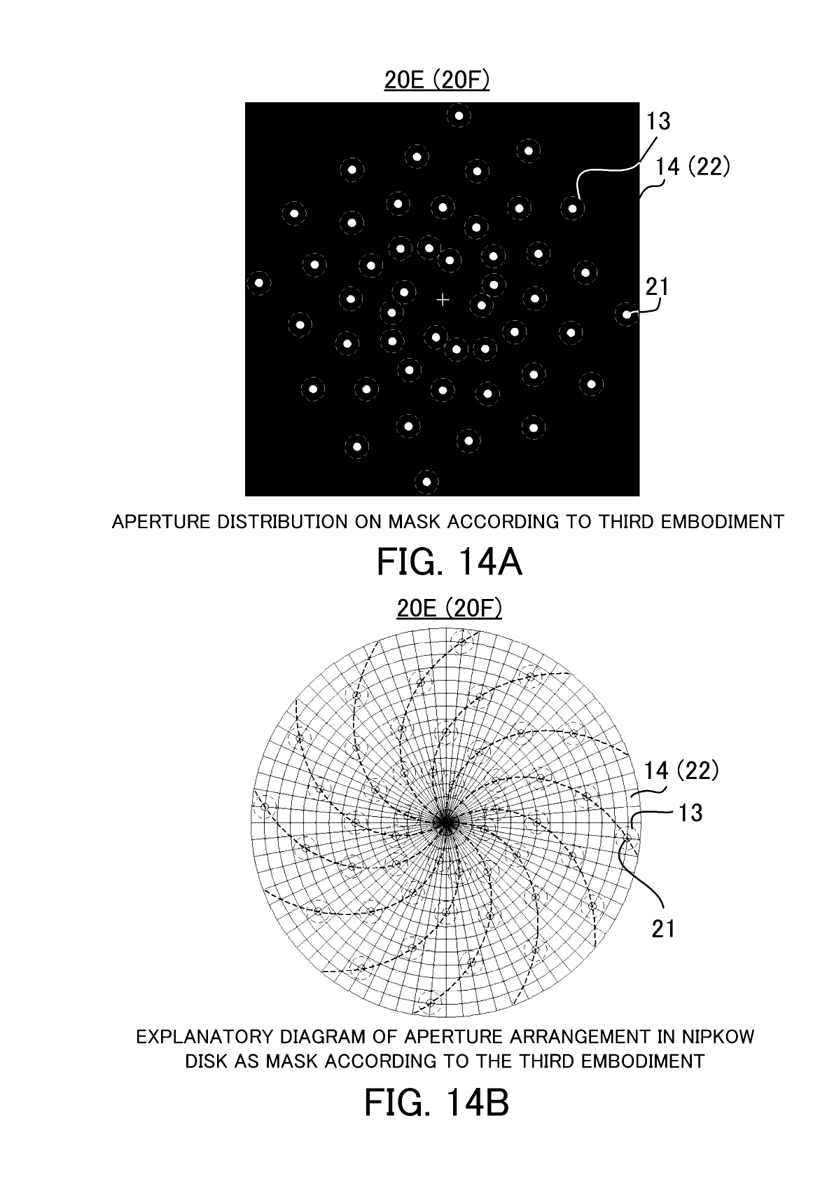

FIG. 14 is a schematic plane view of a partial arrangement state of an unillustrated fiber bundle and masks 20E and 20F according to this embodiment. A white broken line denotes a sectional contour of the aperture 13 in the fiber bundle 13, a white circle denotes the aperture in the masks 20E and 20F, and a cross mark denotes a center of the rotation. The arrangement of a plurality of apertures 13 in the fiber bundle is similar to the aperture arrangement of the Nipkow disk. The Nipkow disk is a disk in which a plurality of pinholes are arranged in a fan or helical shape and aperture positions are multiplexed in a time series by the rotational motion. As a method for timewise multiplexing the space resolution of the apertures, the Nipkow disk is used for beam scanning in an early television set and an early laser confocal microscope.

This embodiment arranges the apertures 21 in the masks 20E and 20F as in the apertures in the Nipkow disk, and the aperture 21 one-to-one corresponds to the aperture 13 in each optical fiber of the fiber bundle. FIG. 14A illustrates a sparse aperture distribution of the fiber bundle for convenience, but actually the apertures are distributed as densely as possible.

FIG. 14B is a more detailed plane view of the partial arrangement state of the fiber bundle and the masks 20E and 20F according to this embodiment. As auxiliary lines used to calculate the aperture positions, concentric circles whose radii increase at regular intervals and radius lines configured to isometrically divide them are drawn. In FIG. 14B, the disk is isometrically divided for each 5°. An illustrated solid-line circle indicates a sectional shape of the aperture 21 in the masks 20E and 20F, and a broken-line circle indicates a sectional shape of the aperture 13 in the fiber bundle, and a pair of the solid-line circle and the broken-line circle is placed on a helical curve drawn by a thick broken line. In comparison with the concentric aperture arrangement illustrated in FIG. 10A, there are the following characteristics. Firstly, the apertures that are adjacent to each other in the circumferential direction shift in the radial direction and are arranged on the helical curve. Secondly, the apertures that are adjacent to each other in the radial direction shift in the circumferential direction and are arranged on the helical curve. Thirdly, the aperture arrangement is the same as the original arrangement when rotated by a predetermined angle (which is 90° in FIG. 14B).

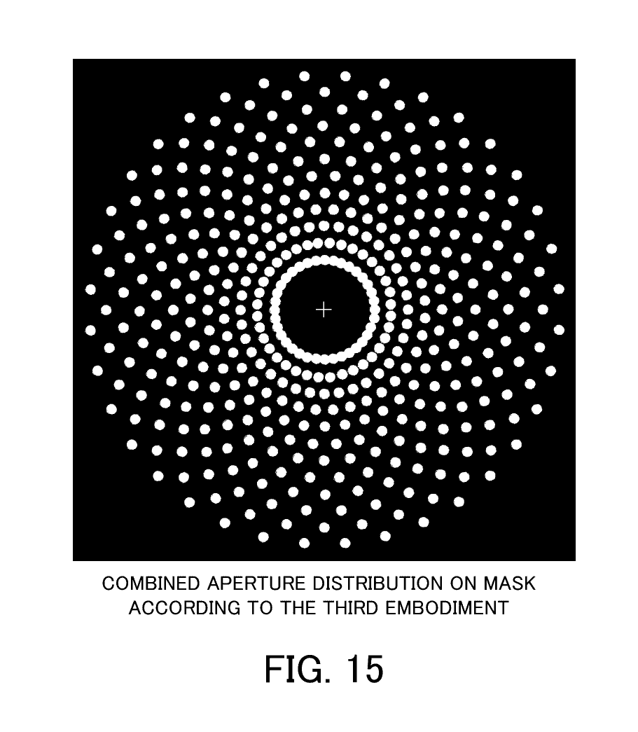

FIG. 15 is a view illustrating an aperture distribution made by rotating the masks 20E and 20F illustrated in FIG. 14A similar to the second embodiment and by combining the available positions of these masks at regular rotational angle pitches. It is understood that FIG. 15 provides a resolution of the apertures both in the radial and circumferential directions higher than that of the apertures 21 illustrated in FIG. 14A, and the entire resolution unevenness is reduced in comparison with the combined aperture distribution in the second embodiment illustrated in FIG. 13.

Where the movement on the end plane of the fiber bundle is a rotational motion, a proper core arrangement in the fiber bundle and a proper shape of the aperture 21 in the mask are not limited to the above embodiments.

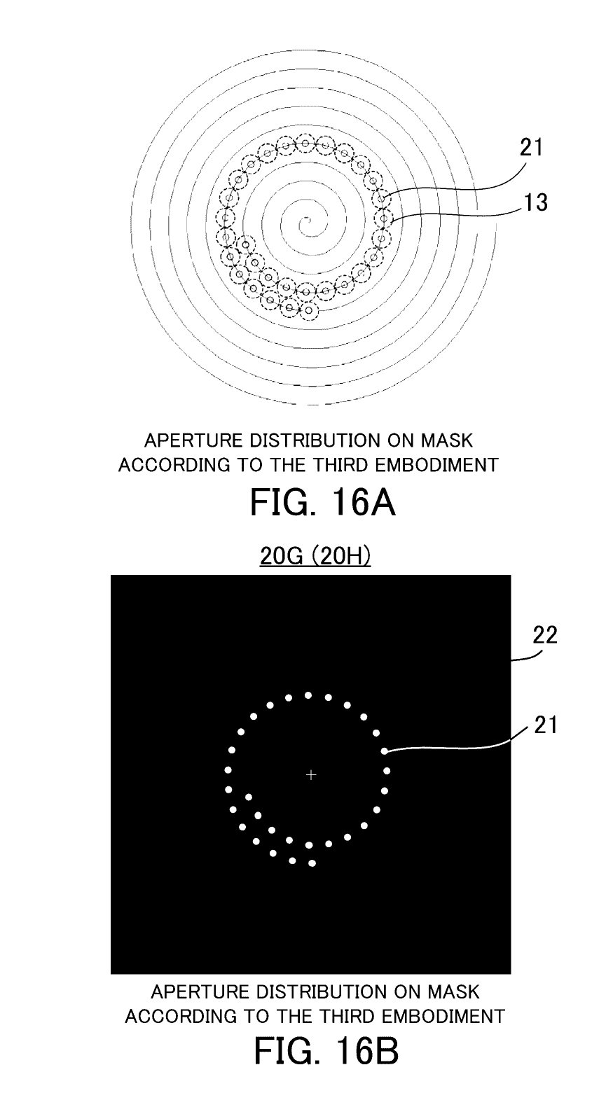

FIG. 16A is a schematic plane view of the partial Archimedean spiral arrangement of the apertures in an unillustrated fiber bundle and masks 20G and 20H according to a variation of the present invention. An illustrated thick broken line denotes a contour shape of the aperture 13 in the fiber bundle, and a solid-line circle denotes a shape of the aperture 21. A thin solid line denotes the Archimedean spiral. The Archimedean spiral is a curve expressed by r=aθ (where “a” is a constant) on a plane with a polar coordinate (r, θ), and has a shape made by spirally winding a long band with a constant width like Mosquito coil. This spiral arrangement can maintain a high fiber density and provide a high resolution image similar to the Nipkow disk. FIG. 16B is a plane view illustrating an aperture distribution on the entrance or exit end plane of the stationary fiber bundle, and illustrates only one wound portion in the eddy for better understanding, although the apertures are actually distributed over the entire surface. In FIG. 16B, the cross mark denotes a center of the Archimedean spiral.

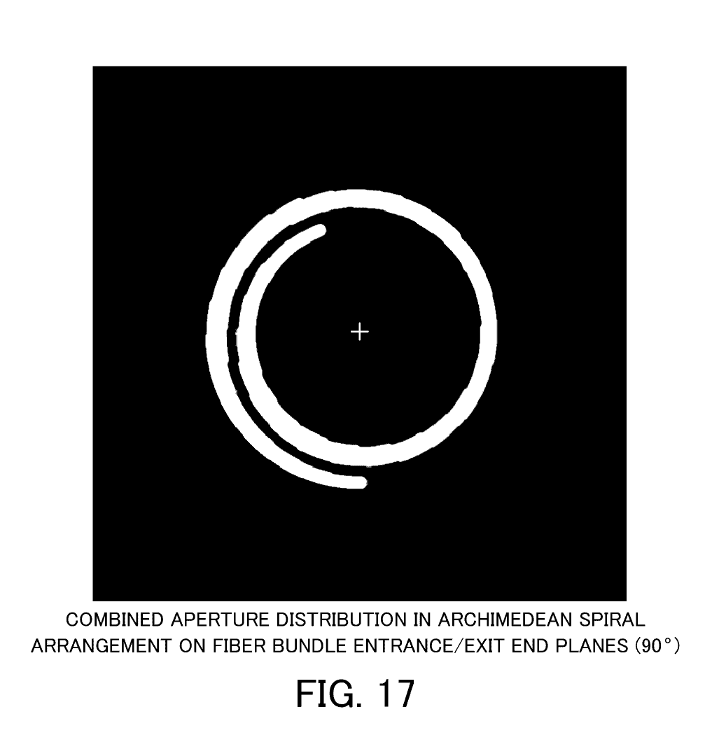

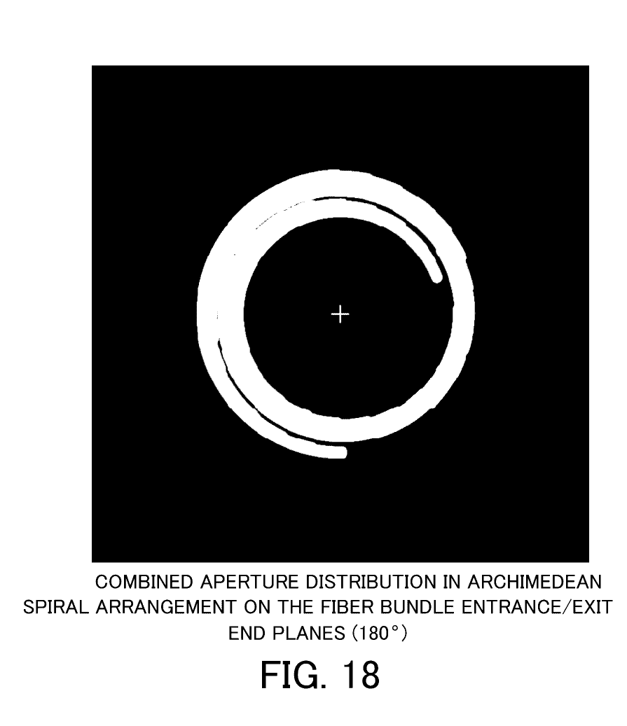

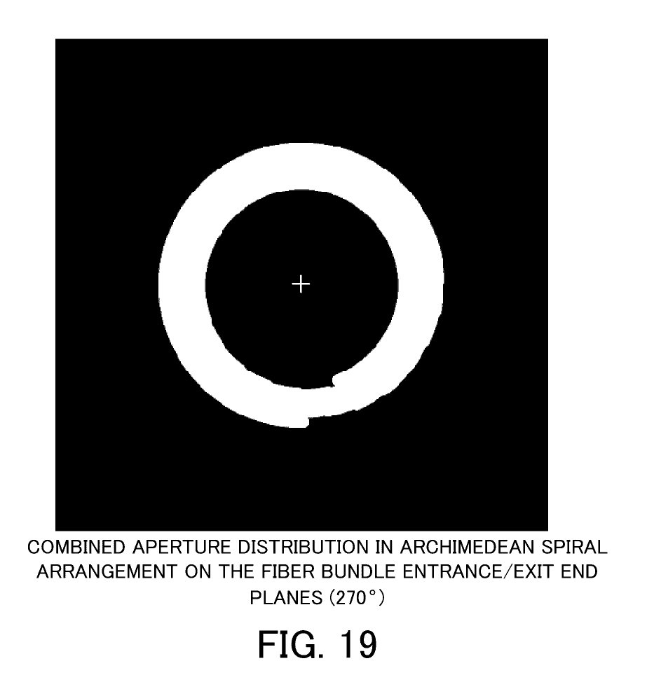

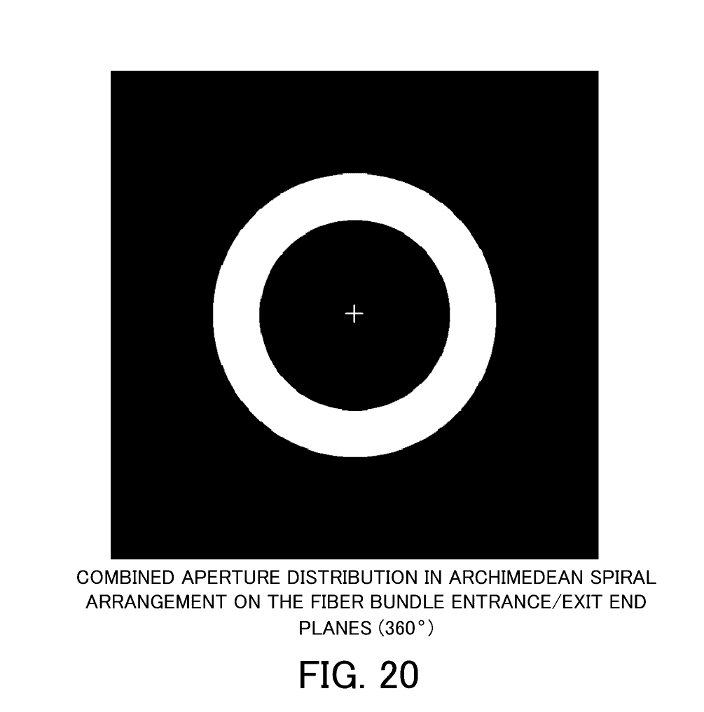

FIGS. 17 to 20 illustrate a combined aperture distribution made by rotating the apertures 21 illustrated in FIG. 16B by 90°, 180°, 270°, and 360° at regular (1°) pitches around the center position of the Archimedean spiral. It is understood that the original apertures among the apertures are interpolated both in the radial and circumferential directions and the resolution evenly improves. Since the resolution is enhanced over all circumferences of the spirally arranged apertures, the resolution is enhanced evenly on the entire surface.

### Fourth Embodiment

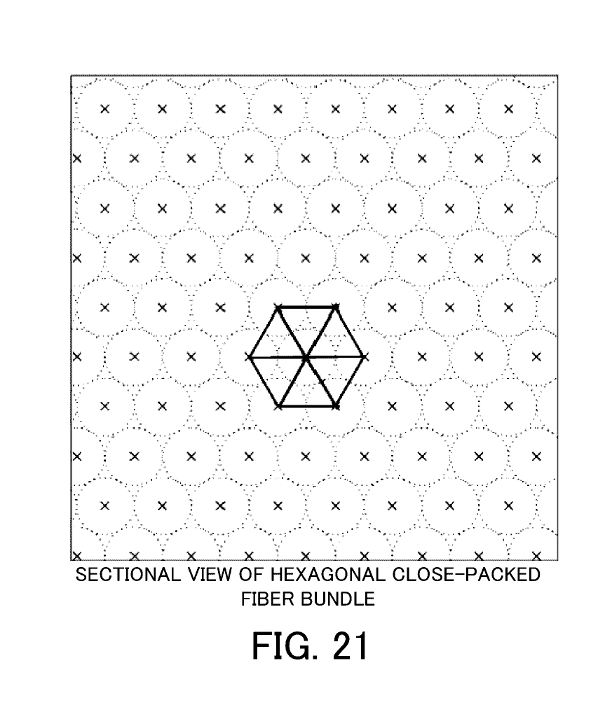

While the third embodiment discusses the aperture distribution on the end plane mask and the fiber bundle for the resolution enhancement both in the radial direction and in the circumferential direction, it is not common to configure the fiber bundle so that the fiber bundle section provides the “Archimedean spiral arrangement” as described above. The fiber bundle of this embodiment is configured to have a hexagonal close-packed shape so as to minimize apertures in the optical fibers. FIG. 21 illustrates the hexagonal close-packed shape, and a vertical section of the fiber bundle. A dotted line denotes an external form line of each optical fiber, and a cross mark denotes a center of each optical fiber on the perpendicular section (referred to as a “fiber center point” hereinafter). As illustrated by a thick solid line, a regular hexagon is formed around an arbitrary fiber center point, in which neighboring fiber center points are distributed in different directions every 60° around the arbitrary fiber center point.

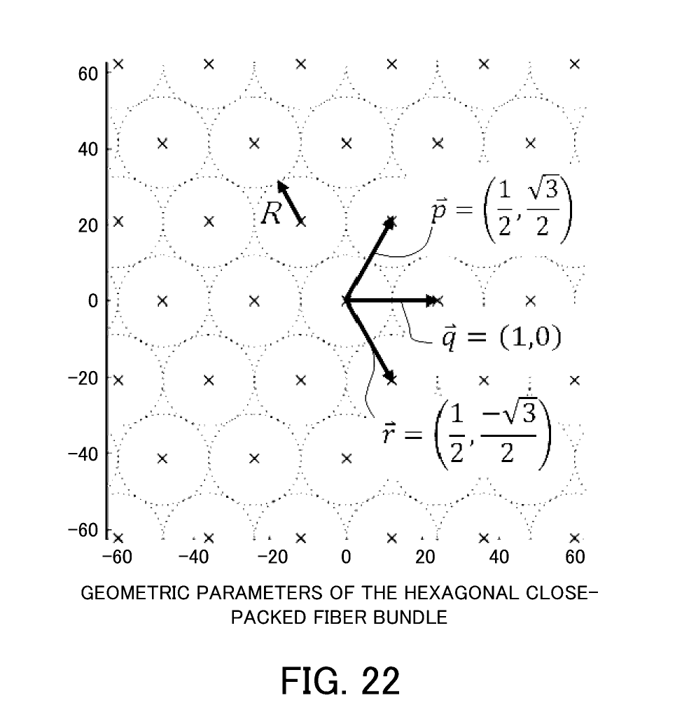

Next follows a description of a method for exercising the present invention using the hexagonal close-packed fiber bundle. Initially, a numerical expression of the hexagonal close-packed fiber bundle will be given. Where the above perpendicular section is set to the XY plane in the Cartesian coordinates, the arbitrary fiber center position (Xo,Yo) exists at a position made by combining three unit vectors \vec{p},\vec{q},\vec{r} illustrated in FIG. 22 and multiplied by an integer. In other words, the following expressions are established where p, q, and r are integers and R is a radius of each optical fiber.

$$\begin{matrix}\vec{p} = ( \frac{1}{2} , \frac{\sqrt{3}}{2} ) \\ \vec{q} = ( 1 , 0 ) \\ \vec{r} = ( \frac{1}{2} , \frac{\sqrt{3}}{2} ) \\ ( {X}_{o} , {Y}_{o} ) = 2 pR \vec{p} + 2 qR \vec{q} + 2 rR \vec{r}\end{matrix} \} \qquad ( 1 )$$

On the other hand, the Archimedean spiral s is expressed by the following expression on a plane with a polar coordinate (s, θ) where “a” is a constant and θ is a variable representing a rotating angle.

s=aθ (2)

Assume that a=R/π. Then, the following expression is established.

$$s = \frac{R}{π} θ \qquad ( 3 )$$

It is understood from the above expressions that as θ increases by π, a distance from the center point (0, 0) to the spiral increases by R. When this is expressed on the Cartesian coordinates, a curve expressed by the following expression is obtained.

$$( x , y ) = ( \frac{R θ}{π} cos θ , \frac{R θ}{π} sin θ ) \qquad ( 4 )$$

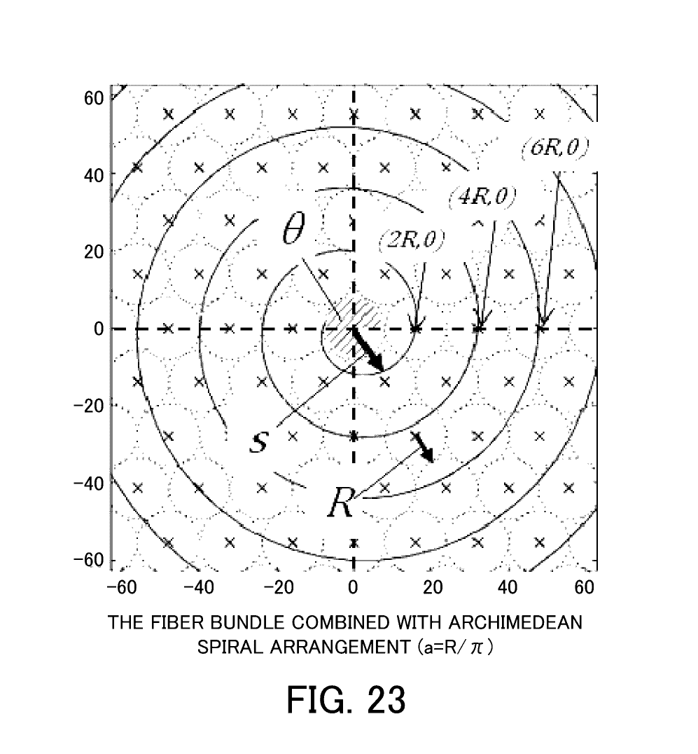

FIG. 23 illustrates the fiber bundle expressed by the expression (1) combined with the Archimedean spiral curve, where a hatched part with bevel lines represents an angle θ. Due to the expression (3), a distance s from the center point (0, 0) to the spiral increases by 2R, such as 2R, 4R, and 6R, for positions with θ=2π, 4π, and 6π. For example, the optical fibers arranged along the x axis intersect the Archimedean spiral at their centers. Thus, the Archimedean spiral curve is characterized in that a distance from the rotational center point increases by 2R every one rotation. On the other hand, a distance between optical fibers is 2R through all areas in the hexagonal close-packed fiber bundle according to this embodiment. As a consequence, one fiber intersects the spiral curve only once rather than twice or more. This is established where the Archimedean spiral curve is set with a=R/π in the expression (2).

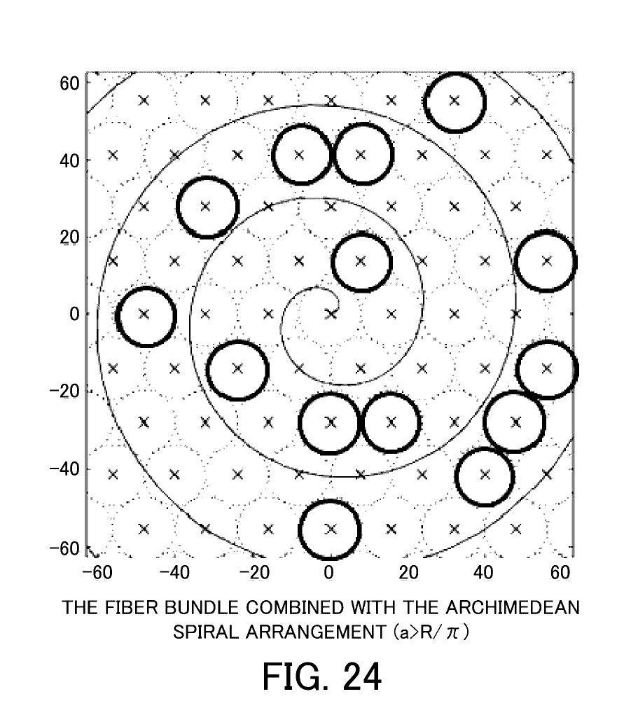

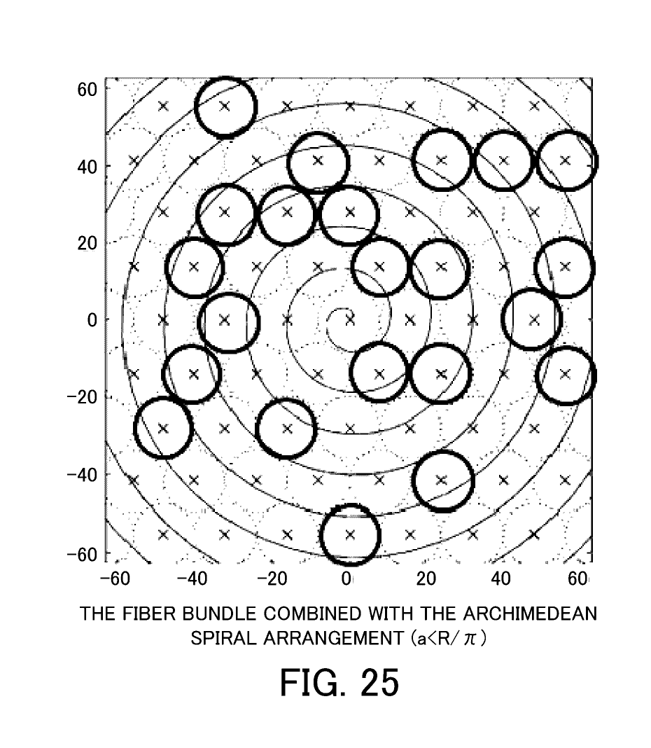

For comparison purposes, cases other than the expression (3) will be analyzed. FIG. 24 illustrates the fiber bundle combined with the Archimedean spiral arrangement with a>R/π in the expression (2), and FIG. 25 illustrates the fiber bundle combined with the Archimedean spiral arrangement with a<R/π in the expression (2). In FIG. 24, a circle illustrated by a thick solid line denotes an optical fiber that never intersects the Archimedean spiral curve. It is understood that there are many such optical fibers. This arrangement is unsuitable for this embodiment when the aperture positions in the masks 20A and 20B are set with the above algorithm because it is necessary for this embodiment to set only one aperture position on the mask to each one fiber as described above. On the other hand, in FIG. 25, a circle illustrated by a thick solid line denotes an optical fiber that intersects the Archimedean spiral curve twice or more. This arrangement is also unsuitable for this embodiment when the aperture positions in the masks 20A and 20B are set with the above algorithm.

Therefore, the embodiment illustrated in FIG. 23 with a=R/π in the expression (2) is suitable for the present invention. In this case, the apertures may be arranged in the masks 20A and 20B along the Archimedean spiral curve expressed by the expression (3) to the fiber bundle 10 that includes a plurality of optical fibers each having a radius R.

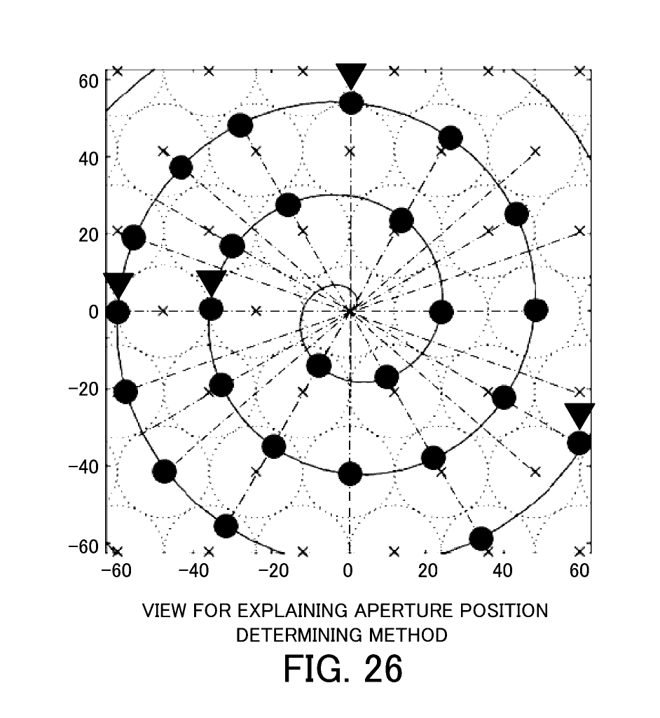

Next follows a description of an algorithm for determining an aperture position on the Archimedean spiral curve on the mask. As described above, only one aperture position is set to each fiber, as described above. Since this embodiment interpolates the image by the rotational motion, distances from the apertures and the rotational center point may distribute at regular intervals. From this viewpoint, as illustrated in FIG. 26, this embodiment sets the aperture position (illustrated as a black dot) to an intersection position between the Archimedean spiral curve and a line that passes the fiber center point and the rotational center point. This configuration can approximately equalize the distance from the rotational center point to each aperture and satisfy the condition that only one aperture position is set to each fiber.

The above aperture position determining algorithm will be expressed with numerical formulas. The aperture position exists at an intersection position between the Archimedean spiral curve and a line that passes the fiber center point and the rotational center point. From the expressions (1) and (4), a real number that satisfies the following expression may be found.

$$( \frac{R θ}{π} cos θ , \frac{R θ}{π} sin θ ) = t ( {X}_{o} , {Y}_{o} ) \qquad ( 5 )$$

When the expression (1) is substituted for the expression (5), the following expression (6) is established.

$$\frac{R θ}{π} ( cos θ , sin θ ) = tR ( p + 2 q + r , \sqrt{3} ( p - r ) ) \qquad ( 6 )$$

The following expression (7) can be led from the expression (6).

$$\begin{matrix}θ = {tan}^{- 1} ( \frac{\sqrt{3} ( p - r )}{p + 2 q + r} ) & ( 7 ) \\ t = \frac{θ cos θ}{π ( p + 2 q + r )} & ( 8 )\end{matrix}$$

It is understood from this result that the point

$$\frac{θ cos θ}{π ( p + 2 q + r )} ( {X}_{o} , {Y}_{o} ) and θ = {tan}^{- 1} ( \frac{\sqrt{3} ( p - r )}{p + 2 q + r} )$$

may be set to the aperture center.

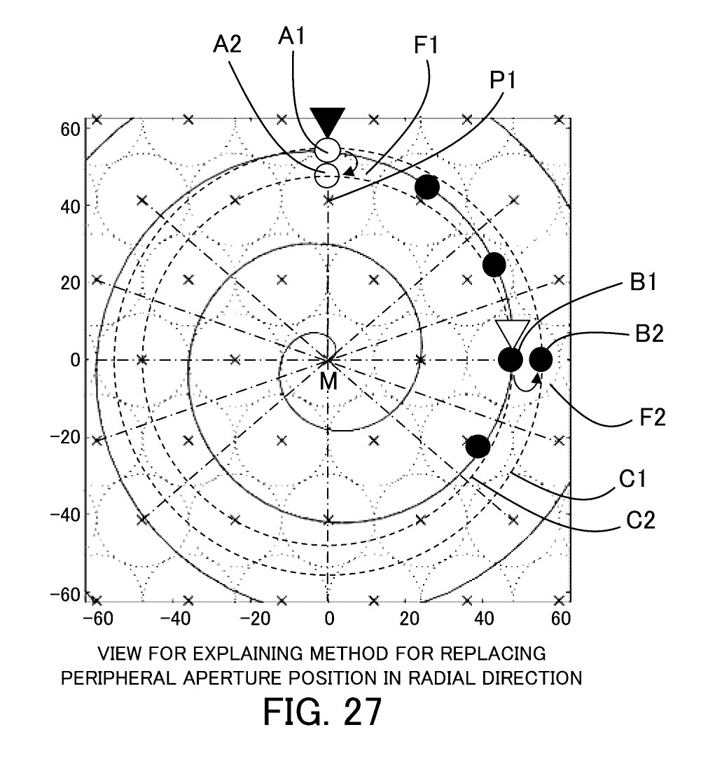

While the above aperture position determining algorithm can uniquely determine the aperture center on the mask, light may leak from the aperture and enter a neighboring fiber if the aperture crosses the contour of the fiber section, since the aperture actually has a finite size. In FIG. 26, such an aperture beyond the fiber is labelled with a black inversed triangle. It is understood from FIG. 26 that the light that has passed this aperture is likely to enter two optical fibers. This problem can be solved by a method for replacing an aperture position in a radial direction. A description will be given of this method with reference to FIG. 27. In FIG. 27, an aperture A1 labelled with a black inversed triangle projects from a certain fiber F1, and all of aperture passing light fluxes do not always enter the fiber F1. Accordingly, the aperture A1 is replaced with an aperture A2 that is closer to a center P1 of the fiber F1 than the aperture A1. As the aperture A2, an aperture that does not project from the fiber F1 and located inside the fiber F1 is selected. Due to this replacement, a distance from the center of the aperture A2 to the rotational center point M becomes a radius of a circle C2 illustrated by a broken line, and changes from a radius of a circle C1 illustrated by a broken line that is a distance from the center of the aperture A1 to the rotational center point M. However, if another aperture has already been set which is apart from the rotational center point M by the distance of the radius of the circle C2, the aperture A2 plays a duplicate role. Accordingly, an aperture with a center located on the circle C2 and on the Archimedean spiral curve is searched. Thereby, an aperture B1 labelled with a white inversed triangle is obtained. Since the aperture B1 is originally located near the center of a fiber F2. Hence, even when aperture B1 apart from the rotational center point M by the radius of the circle C2 is replaced with an aperture B2 apart from the rotational center point M by the radius of the circle C1, the light leak is unlikely to occur from the aperture B2. Whether the light leak occurs or not is determined by determining whether the aperture B2 is located inside the fiber F2. In other words, the aperture A1 is replaced with the aperture A2, and the aperture B1 is replaced with the aperture B2. This aperture replacement can solve the light leak from one aperture in a plurality of fibers, and achieve a purpose of timewise multiplexing and combining the aperture positions without any duplicates or omissions.

As a result, the centers of two apertures A2 and B2 among a plurality of apertures in the mask shift from the Archimedean spiral. The two apertures A2 and B2 include a first aperture (aperture A2) that has a first center apart from the rotational center point M by a first distance (corresponding to the radius of the circle C2) and a second aperture (aperture B2) that has a second center apart from the rotational center point M by a second distance (corresponding to the radius of the circle C1). A position (or the aperture center position of the aperture A1) apart from the rotational center point M by the second distance in a direction from the rotational center point M to the first center and a position (or the aperture center position of the aperture B1) apart from the center of the rotation by the first distance in a direction from the center of the rotation to the second center are located on the Archimedean spiral.

In summary, the algorithm (method) of the radial aperture position replacement includes the steps of:

1) searching for an aperture A1 that projects from a fiber and may cause light to enter a plurality of fibers;

2) replacing the aperture A1 with another aperture A2 that is unlikely to cause light to enter a plurality of fibers;

3) drawing two concentric circles that are a circle C2 having a radius that is equal to a distance from the center of the aperture A2 to the rotational center point M of the fiber bundle and a circle C1 having a radius that is equal to a distance from the center of the aperture A1 to the rotational center point M;

4) searching for another aperture located at an intersection position between the circle C2 and the Archimedean spiral curve;

5) determining whether or not the light leak in a plurality of fibers may occur if the aperture B1 is replaced with an aperture B2 located on the circle C1 in the radial direction; and

6) selecting the aperture B2 when the aperture B2 does not cause the light leak, and returning to 2) for continuous searching when the aperture B2 causes the light leak.

The present invention can improve the resolution of the obtained image without an image sensor having a high frame rate, or an image processing system having a high calculation processing capacity, or the increased number of fibers in the fiber bundle for the fiber scope.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-171658, filed Sep. 1, 2015, and Japanese Patent Application No. 2016-149122, filed on Jul. 29, 2016, which are hereby incorporated by reference herein in their entirety.

What is claimed is:

1. An optical transmission unit comprising:
a plurality of optical transmission paths;
a first aperture limiter configured to limit an aperture on an entrance end of each of the plurality of optical transmission paths;
a second aperture limiter configured to limit an aperture on an exit end of each of the plurality of optical transmission paths; and
a moving unit configured to rotationally move, around an optical axis direction of the transmission paths, at least one of the plurality of optical transmission paths, the first aperture limiter, and the second aperture limiter so that a moving direction and a moving amount of the aperture limited by the first aperture limiter can be equal to those of the aperture limited by the second aperture limiter.

2. The optical transmission unit according to claim 1, wherein each of the first aperture limiter and the second aperture limiter that includes a light blocking portion having an aperture corresponding to and smaller than each aperture on the entrance end and each aperture on the exit end.

3. The optical transmission unit according to claim 1, wherein the moving unit rotationally moves the first aperture limiter and the entrance end integrally, and the second aperture limiter and the exit end integrally.

4. The optical transmission unit according to claim 1, wherein a center of a rotation provided by the moving unit is a center of the plurality of optical transmission paths on a plane perpendicular to an optical axis of the optical transmission path.

5. The optical transmission unit according to claim 1, wherein the moving unit includes:
a rotation driver provided on an exit side of the optical transmission paths; and
a transmitter configured to rotationally move the exit side of the optical transmission paths with a rotational driving force applied by the rotation driver, and to transmit the rotational driving force applied by the driver to an entrance side of the optical transmission paths.

6. The optical transmission unit according to claim 4, wherein the plurality of optical transmission paths have concentrically arranged apertures around the center of the plurality of optical transmission paths on the plane.

7. The optical transmission unit according to claim 6, wherein each of the first aperture limiter and the second aperture limiter includes a light blocking portion that has a plurality of apertures that extend in a radial direction from the center of the plurality of optical transmission paths on the plane, and are arranged at regular angular intervals.

8. The optical transmission unit according to claim 4, wherein the plurality of optical transmission paths have spirally arranged apertures around the center of the plurality of optical transmission paths on the plane.

9. The optical transmission unit according to claim 8, wherein each of the first aperture limiter and the second aperture limiter includes a light blocking portion that has a plurality of apertures that are spirally arranged around the center of the plurality of optical transmission paths on the plane.

10. The optical transmission unit according to claim 8, wherein an arrangement of the spirally arranged apertures is an Archimedean spiral arrangement.

11. The optical transmission unit according to claim 8, wherein each of the first aperture limiter and the second aperture limiter includes a light blocking portion that has a plurality of apertures of an Archimedean spiral arrangement.

12. The optical transmission unit according to claim 1, wherein the plurality of optical transmission paths have a plurality of apertures of a hexagonal close-packed aperture arrangement.

13. The optical transmission unit according to claim 12, wherein each of the first aperture limiter and the second aperture limiter includes a light blocking portion that has a plurality of apertures of an Archimedean spiral arrangement.

14. The optical transmission unit according to claim 13, wherein a spiral curve s that is made by connecting centers of the plurality of apertures in each of the first aperture limiter and the second aperture limiter is expressed by the following expression:
$$s = \frac{R}{π} θ$$
where R is a radius of each optical transmission path, and θ is a variable representing a rotating angle in a polar coordinate (s, θ) space.

15. The optical transmission unit according to claim 14, wherein each of the centers of the plurality of apertures in each of the first aperture limiter and the second aperture limiter is disposed at an intersection position between the spiral curve s and a corresponding one of a plurality of lines each of which is made by connecting a center of each of the plurality of aperture in the optical transmission paths to the center of the rotation provided by the moving unit.

16. The optical transmission unit according to claim 15, wherein each of the centers of the plurality of aperture in each of the first aperture limiter and the second aperture limiter is located at
$$\frac{θ cos θ}{π ( p + 2 q + r )} ( {X}_{o} , {Y}_{o} ) and θ = {tan}^{- 1} ( \frac{\sqrt{3} ( p - r )}{p + 2 q + r} )$$
where θ is a variable representing a rotating angle, p, q, and r are integers, R is a radius of each optical transmission path, and (X₀, Y₀) is a center position of each of the plurality of apertures in the optical transmission paths on the entrance end or the exit end expressed by the following expressions:
$$\begin{matrix}\vec{p} = ( \frac{1}{2} , \frac{\sqrt{3}}{2} ) \\ \vec{q} = ( 1 , 0 ) \\ \vec{r} = ( \frac{1}{2} , \frac{\sqrt{3}}{2} ) \\ ( {X}_{o} , {Y}_{o} ) = 2 pR \vec{p} + 2 qR \vec{q} + 2 rR \vec{r} .\end{matrix}$$

17. The optical transmission unit according to claim 16, wherein centers of two apertures among the plurality of apertures in each of the first aperture limiter and the second aperture limiter shift from the Archimedean spiral, the two apertures include a first aperture that has a first center apart from the center of the rotation by a first distance and a second aperture that has a second center apart from the center of the rotation by a second distance, and a position apart from the center of the rotation by the second distance in a direction from the center of the rotation to the first center and a position apart from the center of the rotation by the first distance in a direction from the center of the rotation to the second center are located on the Archimedean spiral.

18. An image capturing apparatus comprising:
an optical transmission unit; and
an image sensor configured to photoelectrically convert an optical image transmitted by the optical transmission unit,
wherein the optical transmission unit includes:
a plurality of optical transmission paths;
a first aperture limiter configured to limit an aperture on an entrance end of each of the plurality of optical transmission paths;
a second aperture limiter configured to limit an aperture on an exit end of each of the plurality of optical transmission paths; and
a moving unit configured to rotationally move, around an optical axis direction of the transmission paths, at least one of the plurality of optical transmission paths, the first aperture limiter, and the second aperture limiter so that a moving direction and a moving amount of the aperture limited by the first aperture limiter can be equal to those of the aperture limited by the second aperture limiter.

19. The image capturing apparatus according to claim 18, wherein a rotational movement by the moving unit is synchronized with an image acquiring timing by the image sensor.

20. The image capturing apparatus according to claim 19, wherein a minimum size of a pixel in the image sensor is equal to or smaller than each aperture in the optical transmission paths limited by the first aperture limiter and the second aperture limiter.
